(19) United States
(12) Patent Application Publication
(10) Pub. No.: US 2006/0224971 A1
(43) Pub. Date: Oct. 5, 2006

(54) System and method for online multi-media discovery and promotion

(76) Inventors: Matthew Paulin, Seattle, WA (US); Benjimin Chobot, Seattle, WA (US); Jeffrey Davis, Seattle, WA (US); Erik Chelstad, Seattle, WA (US)

Correspondence Address: Gerhard P. Shipley, 300 Clayton Court, Lawrence, KS, 66044, US

(21) Appl. No.: 11/395,442

(22) Filed: Mar. 31, 2006

Related U.S. Application Data
(60) Provisional application No. 60/667,159, filed on Mar. 31, 2005.

(51) Int. Cl. G06Q 99/00

(52) U.S. Cl. 715/758; 715/727; 705/52

(57) ABSTRACT

The present invention concerns a system and method for facilitating discovery and promotion of musical works via an electronic network. Broadly, the method comprises the steps of receiving the musical works from artists; establishing a virtual room; allowing a user to enter the virtual room and select one or more of the musical works to play; and allowing the user to chat with a second user within the virtual room. To this broad idea can be added, as desired, any one or more of a large number of enhancement features that further facilitate the discovery and promotion of the works.

### RELATED APPLICATIONS

The present non-provisional patent application claims priority benefit of an earlier-filed provisional patent application titled “Online Multi-Media Service”, Ser. No. 60/667,159, filed Mar. 31, 2005. The identified earlier-filed patent application is hereby incorporated by reference into the present patent application.

### BACKGROUND OF THE INVENTION

1. Field of the Invention

The present invention concerns a system and method for facilitating discovery and promotion of musical works via an electronic network. Broadly, the method comprises the steps of receiving the musical works from artists; establishing a virtual room; allowing a user to enter the virtual room and select one or more of the musical works to play; and allowing the user to chat with a second user within the virtual room. To this broad idea can be added, as desired, any one or more of a large number of enhancement features that further facilitate the discovery and promotion of the works.

2. Description of the Prior Art

Systems and methods are known for allowing users to play and/or download music via the Internet. These prior art system and methods, however, offer very little else. For example, the user is typically required to search for a specific known artist and/or work by name, which does nothing to facilitate the discovery of new artists and works. Furthermore, other than traditional advertisement mechanisms, nothing is done to promote artists and works. Additionally, nothing is done to enhance the user's experience in terms of participation and interactivity. Additionally, no such systems or methods exist for works other than music.

For these and other reasons, a need exists for an improved system and method for online multi-media discovery and promotion.

### SUMMARY OF THE INVENTION

The present invention overcomes the above-described and other problems and disadvantages in the prior art by providing a system and method for facilitating discovery and promotion of musical works via an electronic network. Broadly, the method comprises the steps of receiving the musical works from artists; establishing a virtual room; allowing a user to enter the virtual room and select one or more of the musical works to play; and allowing the user to chat with a second user within the virtual room. To this broad idea can be added, as desired, any one or more of a large number of enhancement features that further facilitate the discovery and promotion of the works.

One such feature involves assigning the user a role within the room, wherein the role defines a set of abilities of the user with respect to the room and/or other users. Another feature involves allowing the user to restrict access to the room by the second user.

Another feature involves establishing a queue for the one or more user-selected musical works, wherein the works are played substantially in the order in which they appear in the queue. This feature may be further enhanced by allowing the user to spend virtual money to change the order in which the works appear in the queue. The feature may be further enhanced by substantially automatically selecting one or more musical works for the queue, wherein the substantially automatically selected works are selected based upon a substantial similarity with the musical works previously played in the room. The feature may be further enhanced by allowing the user to attempt to prevent a particular musical work appearing in the queue from playing by initiating a vote by the users within the room.

Another feature involves allowing the user to establish and maintain a list of one or more favored musical works, and to rate the one or more favored musical works on a pre-established scale. This feature may be further enhanced by substantially automatically identifying for the user substantially similar musical works based upon the ratings of the favored works.

Another feature involves allowing the user to designate the second user as a friend, wherein the friend has one or more abilities with respect to the user that other users do not have. Another feature involves providing a virtual map of a virtual world including a plurality of rooms, wherein the plurality of rooms includes the room, and wherein the virtual map facilitates the user navigating the virtual world to find the room.

Another feature involves allowing the user to register as a fan of an artist that created one or more of the musical works. This feature may be further enhanced by allowing the artist to access demographic information about the fan.

Another feature involves allowing the user to arrange one or more of the musical works into a collection. This feature may be further enhanced by allowing the user to arrange the collection; allowing the user to identify a recipient; packaging the collection on a suitable medium; and sending the medium to the identified recipient.

Another feature involves allowing the user to establish and maintain a list of one or more of the musical works which reflect a particular mood of the user. And yet another feature involves measuring a volume level of the musical work being played by the user.

These and other important features of the present invention are described in greater detail in the section titled DETAILED DESCRIPTION OF THE INVENTION, set forth below.

### BRIEF DESCRIPTION OF THE FIGURES

FIG. 1 is a depiction of a preferred embodiment of the system of the present invention; and

FIG. 2 is a flowchart of a preferred embodiment of the basic method of the present invention.

### DETAILED DESCRIPTION OF THE INVENTION

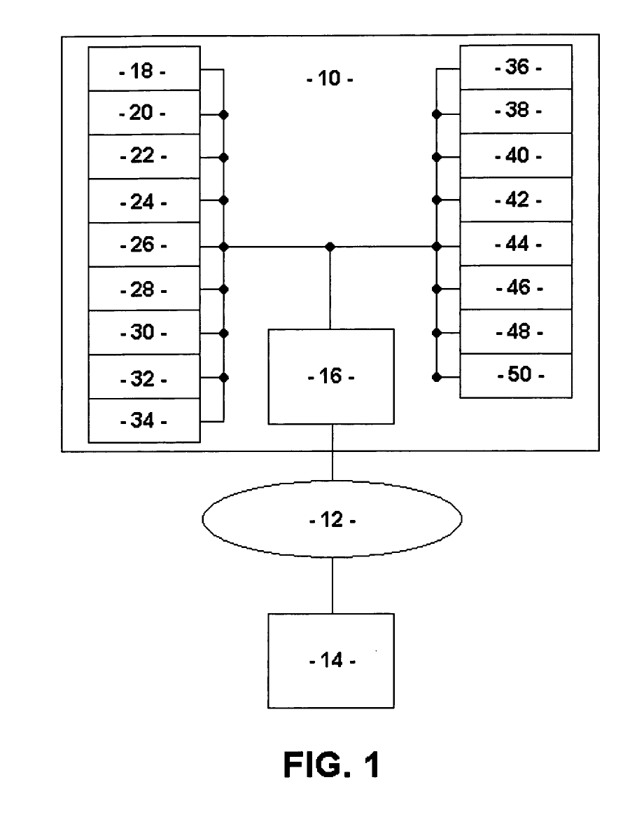

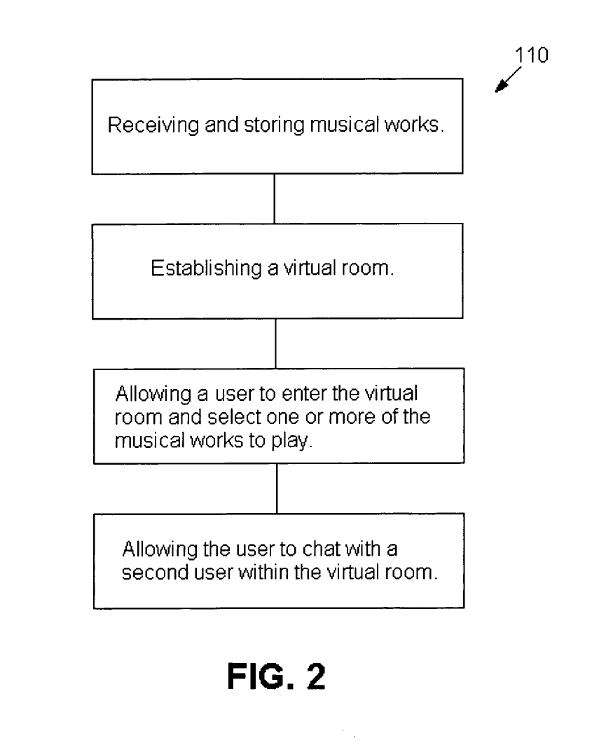

With reference to the figures, a system 10 and method for online multi-media discovery and promotion is herein described, shown, and otherwise disclosed in accordance with a preferred embodiment of the present invention. The system 10, shown in FIG. 1, and method facilitates discovery and promotion of musical works via an electronic network 12, such as, e.g., the Internet, by a user using a computing device 14. Broadly, the basic method 110, shown in FIG. 2, comprises the steps of receiving the musical works from Artists and storing them; establishing a virtual Room 16; allowing a user to enter the virtual Room and select one or more of the musical works to play; and allowing the user to chat with a second user within the virtual Room. To this basic method can be added, as desired, any one or more of a large number of enhancement features, described below, that further facilitate the discovery and promotion of the works.

Artists are allowed to submit, or post, their work, or pieces, and Listeners are allowed to request and enjoy the posted works. Although Listeners are able to request their favorite works, they are also exposed to new works which are requested by their fellow Listeners or selected by the system itself. Unlike a conventional radio station or other media outlet, users of the system have the immediate power to communicate and otherwise interact with their fellow Listeners by, for example, choosing particular works, having conversations, and attaching or otherwise associating comments or ratings to the works. Users gain and spend virtual money, called “points” or “credits” herein, when they engage in system activities.

Though discussed herein as pertaining particularly to musical works, it should be understood and appreciated that the present invention may involve any one or more of a variety of different media, such as, for example, movies, short stories, articles, poetry, short films, music videos, and fine art. Broadly, the system and method comprise a number of innovative concepts including Roles 18; Media Queue 20; AutoDJ 22; Veto 24; Media List 26; Friend 28; Similarity Engine 30; Fan 32; Comment 34; Genre 36; CD Making 38; Mood List 40; Feedback Through Volume Level 42; In-Room Applause 44; Accountability Via Invitations 46; Use of Credits to Change the Order of Songs in the Queue 48; and Geographical Feedback for Artist (Tour Planner) 50. These and other concepts are described in detail below.

Roles 18

Users logging into the system can log in under one of a variety of different Roles, broadly including the Roles of Listener, Artist, Label, Owner, Manager, and Bouncer, each of which has particular abilities with respect to the system, particular Rooms, and other users. A user may have different Roles in different Rooms. For example, a user may be an Owner in one Room and just another Listener in another Room. Roles allow for customization and policing of the world.

A Listener is a regular user who desires to explore and listen to the work that has been entered into the system by an Artist. An Artist is a contributor of one or more works to the system. A Label is a person or legal entity that controls the rights to or has other control over the works of one or more Artists. An Owner has all of the abilities of a Manager, and can promote and demote Listeners to and from the Role of Manager. Room creation and ownership is discussed in greater detail below.

A Manager has all of the abilities of a Bouncer, and can promote and demote Listeners to the Role of Bouncer. A Manager can also can check the messages in the Room's message drop box; can reset and edit the AutoDJ media list used to suggest songs in the Room; can alter the Room's veto parameters, including the parameters of the “turnout value”, which is the minimum number of votes that must be cast, the “threshold value”, which is the average number of votes required for the veto to happen, the “duration”, which is the amount of time a veto will run; and the “Auto Veto”, which, when turned on, automatically vetoes a song that is rated low in the Room. A Manager can also close a Room, thereby preventing any new people from entering the Room, no matter what their status in the system.

A Bouncer can remove people from a Room by adding them to a ban list, and can set the amount of time that a banned person will remain on the ban list (e.g., one day, one month, forever). A Bouncer can also maintain a guest list, which is an alternative to the ban list. More specifically, if a Room chooses to have a ban list instead of a guest list then only people on the ban list are excluded from the Room, whereas if a Room chooses to have a guest list instead of a ban list then only people on the guest list are allowed into the Room.

General User Account Set-Up

At least the following information is requested of a User when he or she signs-up for a new account in order to use the system: a username; a valid email address; an invite code, which is used to link Listener accounts (as discussed below); a country code; and a zipcode. Once the new account has been processed, a password is emailed to the user enabling him or her to log in to the system.

Artist Signup

At least the following information is requested of an Artist when he or she signs-up for a new account: the Artist's or the band's name; an executed legal agreement between the system and the Artist regarding at least the legal rights and abilities of the system; an address to send any profits to, wherein the profits may arise due to purchases of the Artist's products or requests for the Artist's works; and a valid email address. Once the new account has been processed, a password is emailed to the Artist enabling him or her to log in to the system.

Linking Artist Roles to Listeners

Artists load and maintain music; Listeners hear and enjoy the music loaded by the Artists. To link these different perspectives, the system may allow for assigning Artist Roles to Listeners, whereby an Artist can specify a particular Listener to temporarily play a Role in the Artist's band. The Listener could, for example, be temporarily specified as the drummer for the band. Then, when the Listener is logged in to the system, all other Listeners can see him or her identified as the drummer.

Artist Abilities

Artists may have any or all of following abilities. Artists can submit new works, and may be able to submit scores and/or lyrics for works. Artists may be able to arrange works into collections, i.e., “albums”. Artists may be able to deactivate, i.e., render inaccessible, works, but they cannot remove them. Artists may be able to view comments that are associated with the works they have submitted. Artists may be able to view statistics about the works they submitted, such as for example, the number of requests for the works. Each Artist may be able to submit a banner which is broadcast to the chat window of Listeners before the Artist's work is played. Artists may be able to create a list of Listeners and assign a title to each one, which allows the Artist or band members to be recognized as such by the Listeners when they are logged in to the system. Each Artist may be able to set the cost of downloading a high quality version of the Artist's work.

Labels

Labels may be treated as meta-Artists. Typically, a Label has legal control over an Artist or a work, and therefore its consent may be required before the work can be submitted to or played by the system. Labels may be associated with their own special accounts. Labels may have all of the abilities of Artists plus any or all of the following. Labels may be able to add new Artists. Labels may be able to remove Artists.

Real Money

Real money can be spent by Listeners in a number of different ways, including to purchase high quality versions of works or to purchase credits or points which can be used, much like tokens at an arcade, to purchase products or services within the system, such as, for example, to purchase the playing or downloading of works at prices set by the artists. Also, Listeners are charged periodically, e.g., once per month, for the use of the system.

Rooms 16

Rooms allow Listeners to form communities in which they can enjoy similar tastes in music as well as learn about new music from each other. Within a Room, users request a work from the system; the work is queued-up for the Room; and the work is then played through streaming audio.

Rooms may be implemented as follows. Rooms are created by users of the system, and contain Listeners. Each Room may be associated with a description., which may describe, for example, the type of music most often played in the Room, the nature of the chat in the Room, or the general mood of the Room. Each Room may be associated with one or more or, alternatively, only one streaming audio channel, and has a Media Queue that the Listeners can manipulate. Listeners can chat with one another while they are inside a Room. Rooms may be policed by Listeners with special Roles within the Room. As mentioned, for example, a Bouncer has the ability to ban other Listeners from a Room. Rooms may be created and destroyed by administrators of the system. Unused Rooms may be destroyed substantially automatically by the system. Users may be allowed to leave comments in a Room, and related comments may be chained or otherwise associated together. Rooms may be “locked” to allow only certain Listeners on the Guest List (described above) to enter.

Room Creation

Rooms may be created as follows. A minimum number of Listeners, e.g., one or more, or, alternatively, approximately between two and four, are required to request that a Room be created. Each such Listener must spend a pre-established number of points, and each such Listener is considered an “owner” of the established Room. Each Listener may be limited with respect to the number of Rooms he or she may be an owner of. Transferring ownership of a Room to another Listener may not be allowed.

Room Destruction and Removal

Rooms may be destroyed and/or removed as follows. A new or relatively new Room which is not being used may be retained for a minimum period of time, e.g., approximately between one and two days, before it is destroyed and removed from the system. A Room with a history of use may be retained for a relatively longer minimum period of time, e.g., approximately between two and three days, before it is destroyed and removed from the system. Rooms with frequent or continuous use may be retained indefinitely.

Media Queue 20

The Media Queue may be implemented as follows. Each Room is associated with a Media Queue which tracks the works that have been, is being, and will be played in the Room. The next work to be played is based on a priority system, which generally means first-requested-first-played. Listeners are able to view a list of that work, its priority, and who requested it. Each Listener is also able to view a list of which works he or she has requested. Listeners are also able to determine which works have been vetoed; which works were requested by the system (as opposed to another Listener); and which Artist created a particular work. Listeners are able to spend credits to raise the priority of their requested work in the Media Queue (i.e., to change the order in which their requested work will be played). Listeners are able to link multiple works together such that they can be requested as a single block. Room owners are able to allow or disallow blocks of works in their Room. Listeners can also determine which works have been linked together as a single block request for multiple media. The Media Queue can be manipulated by the Room's Owners and Managers. A listeners can “unrequest” a work that he or she has requested before it begins playing.

AutoDJ 22

Broadly, the AutoDJ is a substantially automatic process that selects songs for a Room based on songs that have previously been played in the Room. More specifically, all of the songs played in a Room are saved in a list which can be used to identify similar songs (see, e.g., the Similarity Engine feature, described below). In this way, the Room slowly learns the musical taste of its occupants, thereby making the experience more interesting.

The AutoDJ may be implemented as follows. If no songs have been requested by Listeners, then the system can automatically suggest works based on what has previously been requested in the Room, as reflected by the records of the Media Queue. The AutoDJ will not request blocks of works, and any works requested by the AutoDJ will have the lowest priority in the Media Queue. Room Owners and Managers are able to manipulate the AutoDJ. The AutoDJ may maintain a “black list” of works which cannot be played, either in a particular Room or in the system generally.

Veto 24

Listeners in a Room can choose to move to the next work in the Media Queue by vetoing the current work. This Veto feature may be implemented as follows. To initiate a Veto, a Listener must offer as collateral a pre-established number of points, and if the Veto does not pass (i.e., is not successful) the Listener loses those points. Once the Veto attempt is initiated, the Listeners in the Room have a pre-established amount of time to accept or reject the Veto. The final result of the Veto is a tally of the people who actually voted. A minimum number of votes are required to successfully Veto a work. If a Veto fails, that work cannot be vetoed again until it stops playing.

Media List 26

The Media List allows a Listener to record and remember works that he or she has discovered in the system. This Media List feature may be implemented as follows. Media Lists are stored on the server side. A listed work can be rated based on a scale, such as, for example, a scale of approximately between −4 and 4. A listed work can be associated with a note written by the Listener. Media Lists can be made private in order to prevent at least unauthorized persons from viewing them, and Media Lists can be made public in order to allow anyone to see them. By making his or her Media List public, a Listener can convey an aspect of his or her personality, including his or her taste in music. Public Media Lists can be copied between Listener accounts without the permission of the owners' of the lists; however, the original author of a Media List will remain the same even if the list is passed to different accounts. A public list can be viewed even when the Listener who owns the list is not logged in to the system. A work can be requested from a Media List and entered into the Media Queue to be played. Works can be added to, deleted from, and rearranged on Media Lists. Media Lists can be named and renamed; they can be sent to the accounts of friends; they can contain up to a pre-established maximum number of works, e.g., approximately one hundred. A Listener can add a currently-playing work to his or her Media List. A Listener can import a list to and export a list from his or her own personal computer.

Chat and Communications

The system provides chat and communication features which may be implemented as follows. Two or more Listeners can conventionally chat within a Room. Listeners can also “whisper” to each other in the Room, whereby their communication is made private even with respect to others within the same Room; Listeners can “shout” to each other between Rooms, whereby Listeners in other Rooms are included in the chat; and Listeners can “ignore” particular people in a Room, whereby the chat entries of a Listener being ignored are not received by the Listener doing the ignoring. A shout communicated to an offline Listener may be stored in an offline message area, called a Message Box. Listeners can use emoticons in their chatting.

Message Box

The aforementioned Message Box feature may be implemented as follows. Messages stored in the Message Box are deleted after a period of time. Messages can be sent via the system to the Message Box. Messages from the Message Box can be emailed to the registered account of the Listener. Messages from the Message Box can be deleted before they are cleaned out.

The Message box is used to initiate Friend Invites and accomplish system handshaking. Handshaking can include making friends; linking an Artist account and a Listener account together; and sending credits, points, playlists, or other system artifacts to another account.

Friend 28

Friend features assist users in making friends with other users within the community, and to remember who their friends are. The resulting associations also provide administrators with the ability to prevent abuse of certain other system features. The Friend features may include and be implemented as follows. Each Listeners can create and maintain a friend list. A two-way hand-shake may be required to add new friends to a friend list. Listeners can give potential friends a virtual card or similar device which initiates the two-way hand-shaking. If the Listener to whom the card is given accepts, then each Listener will have the other added to his or her friend list. Friends can be deleted from a friend list. If one Listener deletes a friend, then both Listeners are deleted from each other's friend lists. The friend list may be organized in a tree structure. This allows contact lists to automatically clean themselves, thereby preventing the accumulation of large numbers of dead contacts and preventing ex-friends from being annoying. This should also promote making more friends because the resulting relationships can be ended swiftly and with no consequences. Another benefit is that it keeps the contact network up-to-date and well-maintained by the users in the system.

A shout or message is limited to people on the shouter's, or messager's, friend list. A Listener can locate a friend within the system by selecting him or her from the Listener's friend list. The friend list may indicate which listed friends are currently online.

World Features

The system comprises a series of Rooms, which make up the “world”, through which Listeners can navigate. Such navigation may be implemented as follows. New Listeners may enter the system through a particular Room, which may be referred to as the “Lobby”. Thereafter, each Listener can define a Room, which may be referred to as his or her “Home Room”, which is used as the Listener's default entry point into the system. If a Listener is banned from his or her Home Room, he or she will be sent to the Lobby.

The system may make Room suggestions if the user provides a Media List to tell the system of the user's likes and dislikes, which the system then uses to match the user to a particular Room or type of Room. As mentioned, Listeners may be able to determine where their friends are, e.g., which Rooms they are in. Similar Rooms may be visually linked for the user, thereby providing a media map of the system. Users may be able to determine how many people are in all or some of the Rooms of the system in order to get a feel for where the crowds are. Users can determine how many of their friends are in any or all of the Rooms. Private Rooms, or booths, can be used to explore music in private.

Points

As mentioned, points are used as a trading medium, i.e., virtual money. The points feature may be implemented as follows. Daily Points may be provided which renew each day in order to promote their use. Permanent (“Perma”) Points may be provided that can be used for most real trade.

Points can be purchased with real money. Listeners may be awarded points when they request a song that a number of other Listeners like; points may be awarded for the completion of an online survey; and points may be awarded for high ratings by other Listeners. Points can be used as collateral during a veto; points can be used to purchase Rooms; points can be used to promote works in a Media Queue; points can be given, or transferred, to others for, e.g., services rendered; points can be traded between Listeners; and points can be redeemed for prizes or products. The system may notify users when their points change.

Daily points are restored each night to a pre-established number, so users are able to continue interacting with the system and have no incentive to save daily points. Daily points are used before Perma points. Within the system, daily and Perma points are substantially interchangeable except that users can only send Perma points, not daily points, to other users.

Similarity Engine 30

The Similarity Engine is used within and by the system in a number of ways. Broadly, the Similarity Engine is operable, when provided with a list of works that has been rated, to substantially automatically identify works similar to the listed works. In one embodiment, the Similarity Engine relies on the assumption that all songs are, at least to some degree, similar to all other songs, and this degree of similarity can be represented as a weight value. The weight value might be based on, for example, the number of Media Lists on which songs appear together (the assumption being that if two songs appear on the same list then they must be more similar than two songs that do not).

The Similarity Engine feature may be implemented as follows. The Similarity Engine may make suggestions of works to the AutoDJ; may suggest “best fit” Rooms for a particular Listener based on the Media List he or she presents; and may suggest “best fit” relationships for Listeners based on the Media Lists that each presents.

Fan 32

If a Listener likes a particular Artist, then he or she can register, or subscribe, as a “fan” of that Artist. The Fan feature may be implemented as follows. The Fan feature may allows Artists to send messages to all of their fans via the Listener Message System, and allows Artists to notify fans when new works are released or concerts are scheduled. The Fan feature may allow Listeners to unsubscribe as fans of an Artists at any time. The Fan feature may allow Artists to see how many fans they have, and to quickly and easily determine their demographic information about their fans. Fans may be able to obtain lists of works produced by the Artists of which they are fans.

Media Properties

All works loaded into the system will have the following information stored with it, which a Listener can access: length of time in seconds; artist(s); label; release date; comments by other Listeners; lyrics; and genre.

Comment 34

As mentioned, Listeners can post comments regarding works. The Comment feature may be implemented as follows. Every Listener may be able to create comments of their own and view the comments of others. Listeners will be able to rate posted comments on a pre-established scale, such as, for example, from −5 to 5, in any or all of a number of pre-established categories, such as, for example, humor; informativeness; gossip; relevance rating; and annoyance. Listeners may be able to establish filters for use when browsing comments made about works, which allow for limiting the types of comments that are seen by the Listeners.

Additional Discovery Tools

A number of tools may be provided to Listeners for finding new works in the system, including the following tools. A Search tool allows users to search the system for works that match any or all of a number of pre-specified criteria, such as, for example, artist; title; lyrics; genre; album; label; and a date range of when the work was loaded into the system. A Suggest tool provides users with suggestions for exploring additional works based on how they rated the works in their Media Lists. A Similar tool informs users as to which works are similar to works the Listener has identified; users may be able to selectively define the degree of similarity between the tool-identified works and the user-identified works.

Media Submission Rules

Works may be submitted under any or all of the following rules. Music must be submitted as mp3, wave, or vorbis files, or their equivalents. Once submitted, works cannot be removed from the system, only “deactivated”, i.e., made unavailable. A previously submitted work cannot be updated, i.e., replaced, with a new version of that work; instead, the new version will simply have a different identifier within the system. Duplications may not be allowed; submitted works are checked to determine whether the identical work has already been submitted; however, this rule may allow for submitting higher quality copies of existing works.

Genre 36

The Genre feature allows artists to identify their works with particular categories, making it easier for Listeners to find works in particular genres. The genre feature may be implemented as follows. Works may be listed in multiple categories. Artists may be able to identify the categories for their works. Artists may be able to submit suggestions for new categories. For the latter feature, each such submission may require the identification of three works which exemplify the suggested category.

Statistics

The system may track a number of different statistics, including, for example, the number of times that a work has been requested; the number of Listeners who have added a work to their Media Lists; the ratings for a work; the total number of times that a work has played in the system; the play ranking of a work; the number of purchases of a work; the purchase ranking of a work; the request ranking of a work; the average age of Listeners that have requested a work; and the number of times that a work has been vetoed.

Ring Tone

Users may be able to turn a work or portion of a work into a ringtone or other tone for an electronic device, such as, for example, a cell phone.

CD Making 38

The system may allow a user to turn part or all of a Media List playlist, or other list of works, into a compact disc or other suitable medium that is then mailed by the system to a person designated by the user. This feature advantageously increases convenience and allows users to easily create and send gifts from works which they have experienced in the system. This feature may also be used as a marketing tool to urge the giftee to join the system.

Mood List 40

A Mood List is a special list of songs that identifies or reflects a mood of the creator or player of the list. The songs on the Mood List provide a mechanism for identifying the emotions of the person. This feature may allow users to identify other users who are in the same mood. If two users have the same taste in music and the same mood then they may be very similar people. Thus, this feature can be used as a match-making tool. It can also allow a user to find a Room that matches his or her current moods; the Room's mood may be determined by the songs that have been played in it recently.

Feedback Through Volume Level 42

The system may collect feedback about particular works by determining whether Listeners increase or decrease the volume of their speakers when listening to the works.

In-Room Applause 44

The In-Room Applause feature allows Listeners in a Room to virtually “applaud” a work while the work is playing, thereby indicating that they enjoy the work. The applause level indicates the responsiveness of the Room and how interested it is in that type of music. Because all the other users in the Room see this information, the level of applause provides feedback which allows users to “train” each other with respect to which songs or types of songs to request. The highest or final applause value is captured by the system so that it can determine how interested the people were in that work, thereby effectively rating the song and telling the Room what to request or the AutoDJ what to play.

Accountability Via Invitations 46

Online worlds are notoriously difficult to control. The use of disposable accounts allows a malicious user to continually return to an online community with a different name and profile, thereby circumventing security. To prevent this, the present invention may require that a new user be invited to join by an existing user. Thereafter, if a user displays unacceptable behavior or is otherwise deemed undesirable, he or she can be removed from the system. If the user is removed and then creates another account to get back in, it is possible to identify the account that keeps inviting the undesirable person back. Ultimately, the inviting user can be confronted and required to stop inviting the undesirable person or be removed him- or herself. This added accountability allows the system to track bad behavior and enforce rules to stop undesirable behavior.

Use of Points to Change the Order of Songs in the Media Queue 48

The system allows a user to request a particular work, but the requested work may be far down in the Media Queue. The system may therefore provide an ongoing auction to allow users to pay points to promote their works closer to the top of the Media Queue. The work with the highest bid wins and is played next; works with lesser bids are played in order of the values of their bids. In one embodiment, this feature may not be used to move songs lower in the Media Queue because doing so would be negative and therefore undesirable behavior. Thus, instead of demoting disliked works, users must positively promote their favorite works.

Geographical Feedback for Artist (Tour Planner) 50

The general location of a Listener is known to the system through the Listener's zip code. Additionally or alternatively, the Listener's location may be derived from the IP address from which he or she connects to the system. The information may be used to provide Artists with an indication of where their fans are concentrated. Thus, each Artist can quickly and easily determine, for example, the locations of people who are purchasing his or her works, adding his or her works to their Media Lists, and/or registering as her or her fans. This information can be particularly useful to the Artist when planning tours. More specifically, the Artist can quickly and easily determine the best locations to maximize concert attendance. Additionally, the system can be used to send a message to Listeners in those locations of the upcoming concert.

Given the disclosure set forth herein, the implementation of the present invention, including all of the various features, is within the ordinary skill of one in the computer programming arts without requiring undue experimentation.

Although the invention has been described with reference to the preferred embodiments illustrated in the drawings, it is noted that equivalents may be employed and substitutions made herein without departing from the scope of the invention as recited in the claims.

Having thus described the invention, what is claimed as new and desired to be protected by Letters Patent includes the following:

1. A method of facilitating discovery and promotion of musical works via an electronic network, the method comprising the steps of:
(a) receiving and storing the musical works;
(b) establishing a virtual room;
(c) allowing a user to enter the virtual room and select one or more of the musical works to play; and
(d) allowing the user to chat with a second user within the virtual room.

2. The method as set forth in claim 1, further including the step of assigning the user a role within the room, wherein the role defines a set of abilities of the user with respect to the room.

3. The method as set forth in claim 1, further including the step of allowing the user to restrict access to the room by the second user.

4. The method as set forth in claim 1, further including the step of establishing a queue for the one or more user-selected musical works, wherein the one or more user-selected musical works are played substantially in the order in which they appear in the queue.

5. The method as set forth in claim 4, further including the step of allowing the user to spend virtual money to change the order in which the one or more user-selected musical works appear in the queue.

6. The method as set forth in claim 4, further including the step of substantially automatically selecting one or more musical works for the queue, wherein the substantially automatically selected one or more musical works are selected based upon a substantial similarity with the musical works previously played in the room.

7. The method as set forth in claim 4, wherein the one or more substantially automatically selected musical works appear at the end of the queue.

8. The method as set forth in claim 4, further including the step of allowing the user to attempt to prevent a particular musical work appearing in the queue from playing by initiating a vote by the user and the second user.

9. The method as set forth in claim 1, further including the step of allowing the user to establish and maintain a list of one or more favored musical works, and to rate the one or more favored musical works on a pre-established scale.

10. The method as set forth in claim 9, further including the step of substantially automatically identifying for the user substantially similar musical works based upon the ratings of the one or more favored musical works.

11. The method as set forth in claim 1, further including the step of allowing the user to designate the second user as a friend, wherein the friend has one or more abilities with respect to the user that other users do not have.

12. The method as set forth in claim 1, further including the step of providing a virtual map of a virtual world including a plurality of rooms, wherein the plurality of rooms includes the room, and wherein the virtual map facilitates the user navigating the virtual world to find the room.

13. The method as set forth in claim 1, further including the step of allowing the user to register as a fan of an artist that created one or more of the musical works.

14. The method as set forth in claim 13, further including the step of allowing the artist to access demographic information about the fan.

15. The method as set forth in claim 1, further including the step of allowing the user to arrange one or more of the musical works into a collection.

16. The method as set forth in claim 16, further including the steps of—
allowing the user to arrange the collection;
allowing the user to identify a recipient;
packaging the collection on a suitable medium; and
sending the medium to the identified recipient.

17. The method as set forth in claim 1, further including the step of allowing the user to establish and maintain a list of one or more of the musical works which reflect a mood of the user.

18. The method as set forth in claim 1, further including the step of measuring a volume level of the musical work being played by the user.

19. A method of facilitating discovery and promotion of musical works via an electronic network, the method comprising the steps of:
(a) receiving and storing the musical works;
(b) establishing a virtual room;
(c) allowing a user and a second user to enter the virtual room and select one or more of the musical works to play;
(d) allowing the user to chat with a second user within the virtual room;
(e) establishing a queue for the one or more user-selected musical works, wherein the one or more user-selected musical works are played substantially in the order in which they appear in the queue;
(f) allowing the user to spend virtual money to change the order in which the one or more user-selected musical works appear in the queue;
(g) substantially automatically selecting one or more musical works for the queue, wherein the one or more substantially automatically selected musical works are selected based upon a substantial similarity with the musical works previously played in the room, wherein the one or more substantially automatically selected musical works appear at the end of the queue; and
(h) allowing the user to attempt to prevent a particular musical work appearing in the queue from playing by initiating a vote by the user and the second user.

20. A method of facilitating discovery and promotion of musical works via an electronic network, the method comprising the steps of:
(a) receiving and storing the musical works;
(b) establishing a virtual room;
(c) allowing a user to enter the virtual room and select one or more of the musical works to play;
(d) allowing the user to arrange one or more of the musical works into a collection;
(e) allowing the user to identify a recipient;
(f) packaging the collection on a suitable medium; and
(g) sending the medium to the identified recipient.
